(19) United States
(12) Patent Application Publication
(10) Pub. No.: US 2026/0161515 A1
(43) Pub. Date: Jun. 11, 2026

(54) UNIFIED AND OPERATING SYSTEM INDEPENDENT SYSTEMS FOR INSTANT ACCESS OF BACKUP COPIES OF DISKS FOR APPLICATION HOSTS

(71) Applicant: Dell Products L.P., Round Rock, TX (US)

(72) Inventors: Tobin George Joseph Pulikeel, Kerala (IN); Sunil Kumar, Bangalore (IN); Vivek Kumar Soni, Ranchi (IN)

(21) Appl. No.: 18/970,473

(22) Filed: Dec. 5, 2024

(51) Int. Cl. G06F 11/14; G06F 16/188

(52) U.S. Cl. CPC G06F 11/1469; G06F 16/188; G06F 2201/815

(57) ABSTRACT

A method for recovering a portion of a backup image includes obtaining, by a proxy data mover and from a host operating system, a request for accessing a file in the backup image. In response to the request, the proxy data mover utilizes a virtual file system manager to identify, from a plurality of subsystem volumes, a subsystem volume of the plurality of subsystem volume associated with the file, where the subsystem volume is used to identify a storage location of the file in the backup image, and wherein each of the plurality of subsystem volumes is associated with a portion of the backup image. The proxy data mover further accesses a backup storage system using the subsystem volumes to access the backup image, obtains, after the accessing, the file from the backup image, and provides the file to the host operating system.

### BACKGROUND

Backup applications are a useful factor in enterprise infrastructure. Backups may be performed on a regular basis. Based on the size of assets backed up, the backups of the assets may comprise a large amount of data. Backing up and restoring this data may require a large amount of computing resources.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of a host in accordance with one or more embodiments of the invention.

FIG. 3A shows a flowchart of a method for configuring a proxy data mover with a virtual file system in accordance with one or more embodiments of the invention.

FIG. 3B shows a flowchart of a method for generating a set of subsystem volumes in accordance with one or more embodiments of the invention.

FIG. 3C shows a flowchart of a method for restoring data from a backup storage system in accordance with one or more embodiments of the invention.

FIGS. 4A-4B show an example in accordance with one or more embodiments of the invention.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details, and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this disclosure, elements of figures may be labeled as A to N, A to P, A to M, or A to L. As used herein, the aforementioned labeling means that the element may include any number of items, and does not require that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

Embodiments of the invention include a method which can be used to perform an operational recovery from the backup disk image of large storage system volumes (without performing the full restore from the backup copy) by enabling the access of a backup image as subsystem volumes by a proxy data mover accessible over network to any host operating system (OS) that includes a data mover interface manager. Once the subsystem volumes get mounted to the host OS, the host OS may browse through the backed-up data and choose the necessary data (e.g., a portion of a backup image) to restore and copy it from the mounted volume to host attached local storage.

Various embodiments of the invention are described below.

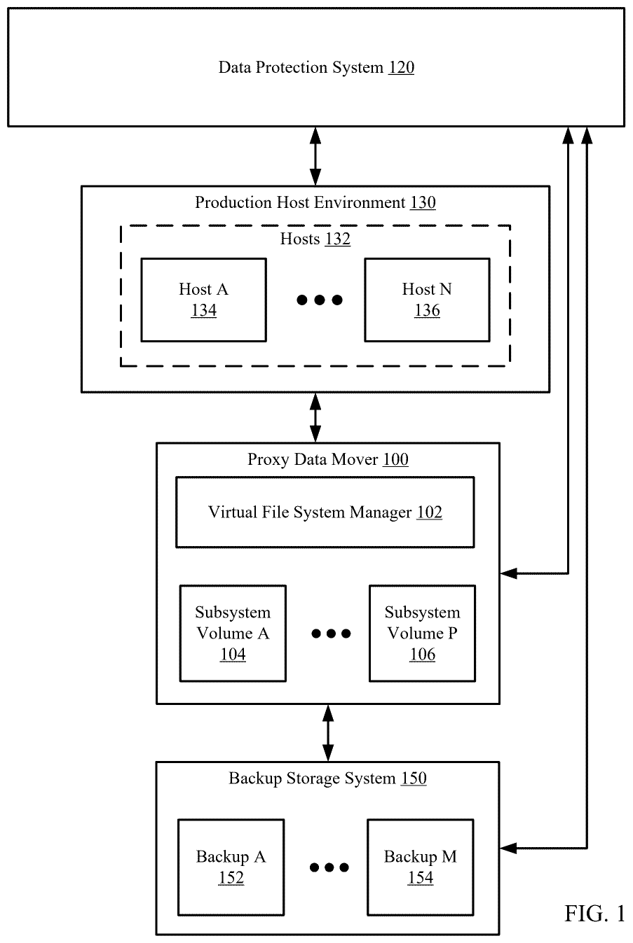

FIG. 1 shows a diagram of a system in accordance with one or more embodiments of the invention. The system (100) includes a data protection system (120), a production host environment (130), a proxy data mover (100), and a backup storage system (150). The system (100) of FIG. 1 may include additional, different, and/or different components without departing from the invention.

In one or more embodiments of the invention, the data protection system (120) includes functionality for performing discovery of assets and initiating data protection operations of the assets. The assets may be, for example, file systems, application data, operating systems, virtual disks, and/or other assets without departing from the invention. The data protection operations may result in backups (152, 154) stored in the backup storage system (150).

In one or more embodiments of the invention, the backups (152, 154) are backup images of an operating system of the production host environment (130). The backup images may store entire OS configurations, file systems, applications, computing resource information, network information, and/or any other data associated with an asset without departing from the invention. The backups (152, 154) may be implemented as, for example, virtual disks.

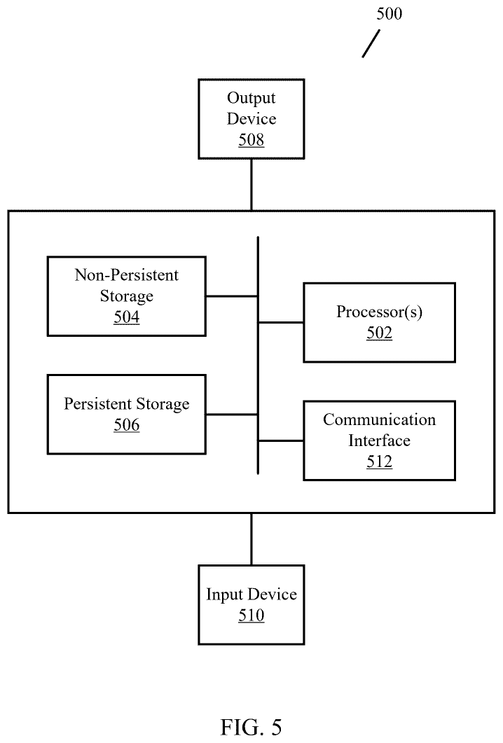

In one or more embodiments disclosed herein, the data protection system (120) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the data protection system (120) described throughout this application.

In one or more embodiments disclosed herein, the data protection system (120) is implemented as a logical device. The logical device may utilize the computing resources of any number of computing devices and thereby provide the functionality of the data protection system (120) described throughout this application.

In one or more embodiments, the production host environment (130) includes functionality for providing services to users. The services may be provided using one or more hosts (132) that each use computing resources for providing the services. The services may be instances of applications, operating systems, virtual machines, and/or any other services without departing from the invention. The hosts (132) may use the data protection system (120) to protect any data generated or otherwise used by the hosts (132) to provide the services to the users.

In one or more embodiments, each host (134, 136) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the host (134, 136) described throughout this application.

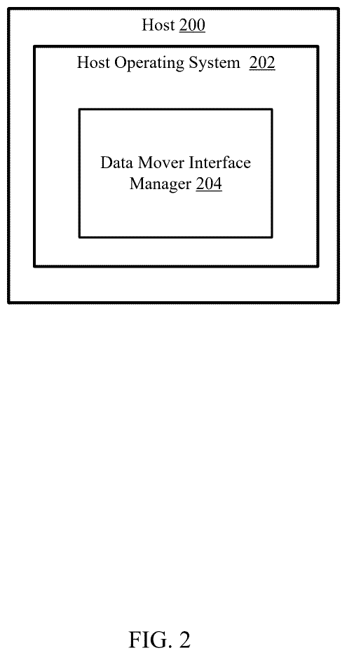

In one or more embodiments disclosed herein, each host (134, 136) is implemented as a logical device. The logical device may utilize the computing resources of any number of computing devices and thereby provide the functionality of the host (134, 136) described throughout this application. For additional details regarding a host (134, 136), refer to FIG. 2.

In one or more embodiments, the proxy data mover (100) include functionality for transmitting data from the backup storage system (150) to the production host environment (130). Further, the proxy data mover (100) may include functionality for issuing requests for servicing requests for recovering the data from the backup storage system (150) to the production host environment.

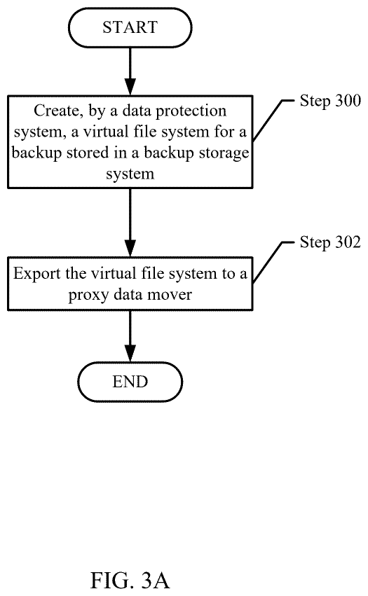

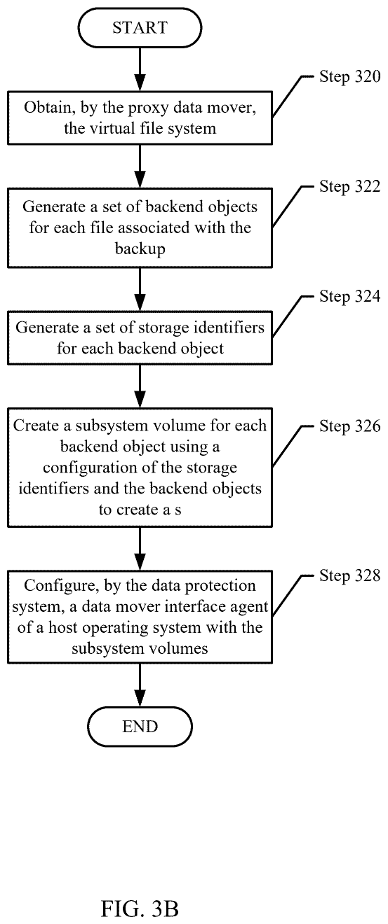

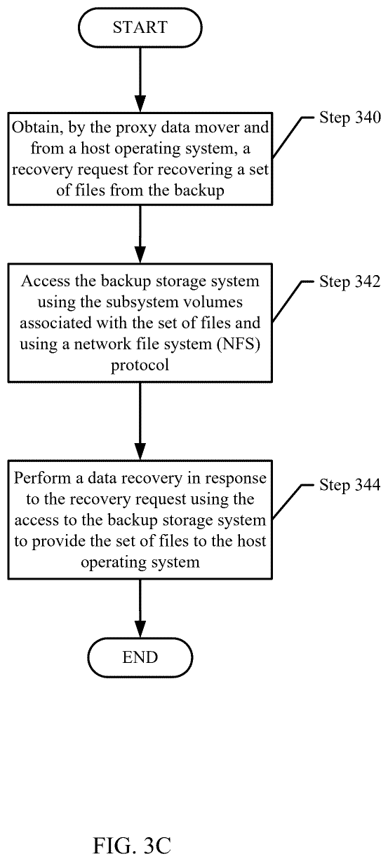

To perform the aforementioned functionality, the proxy data mover (100) includes a virtual file system manager (102) that provides the recovery of data from a backup image to the hosts (132). The virtual file system manager (102) may obtain a virtual file system from the data protection system (120) that maps the storage of data in the backup storage system (150) to virtual synthetic files that may be used to restore the data to the hosts (134, 136). The virtual file system manager (102) may perform such functionality in accordance with, for example, FIGS. 3B-3C.

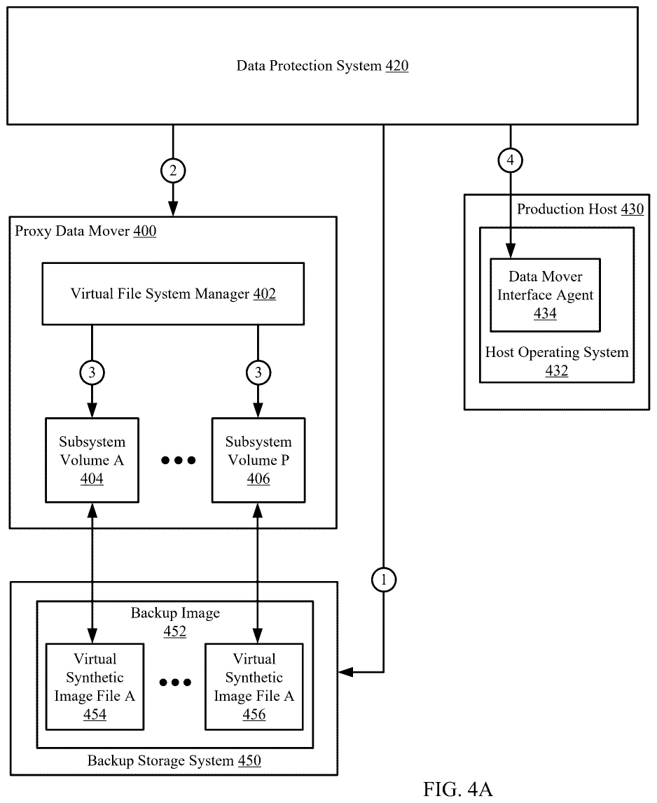

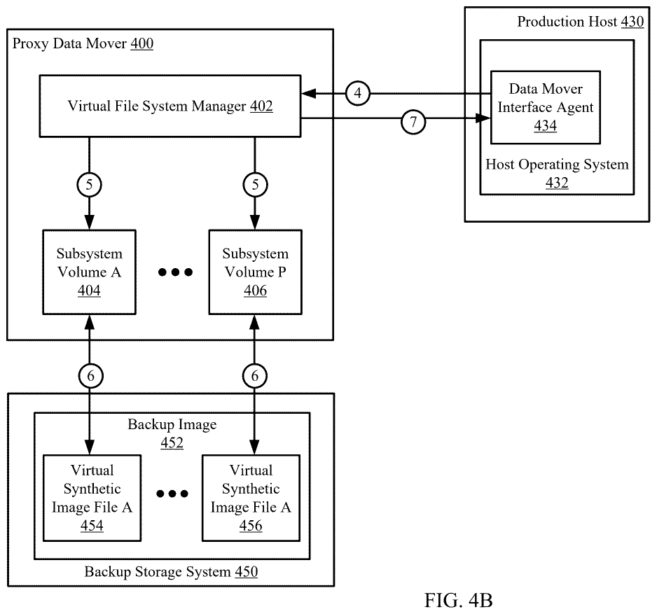

In one or more embodiments, the proxy data mover (100) includes functionality for generating any number of subsystem volumes (104, 106). The subsystem volumes (104, 106) may be a data structure that is used to access portions of data from one of the backups (152, 154). For example, the subsystem may be a system of backend objects and storage identifiers (see FIG. 4A) that, at least collectively, specify information for accessing such portions.

For example, a subsystem volume A (104) may include a backend object (see FIG. 4A) that includes metadata for accessing data in a backup storage system. The data accessed by a backend object may include a portion of a backup image (e.g., a backup (152, 154)). The portion may be, for example, the contents a file of a file system, operating system information, a file system, an application of an operating system, and/or any other information without departing from the invention. The backend object may provide sufficient information such as, for example, chunk information, drive location information, memory address, etc. of the backup storage system (150), such that the proxy data mover (100) may access the corresponding data in the backup storage system. The backend object may be represented as a volume of storage.

In one or more embodiments, the storage identifiers (see FIG. 4A) of a subsystem volume (104, 106) is each a data structure that maps a virtual synthetic file to the corresponding backend object. The virtual synthetic file may be a representation of the portion of a backup image in a virtual file system managed by the virtual file system manager (102). The storage identifiers may be provided to the hosts (132) via a predefined data transmission protocol. Examples of data transmission protocols used by the proxy data mover (100) and a host (134, 136) include, for example, internet small computer system interface (iSCSI) and transmission control protocol (TCP). Other protocols may be used without departing from the invention.

In one or more embodiments, the proxy data mover (100) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the proxy data mover (100) described throughout this application.

In one or more embodiments disclosed herein, the proxy data mover (100) are each implemented as a logical device. The logical device may utilize the computing resources of any number of computing devices and thereby provide the functionality of the proxy data mover (100) described throughout this application.

In one or more embodiments, the backup storage system (150) stores backups (152, 154) of assets in accordance with data protection operations. Each device in the backup storage system (150) may be associated with a network address (e.g., an internet protocol (IP) address). The information corresponding to backups (152, 154) stored in the backup storage system (150) and any storage location information associated with a backup may be managed by the data protection system (120). Said another way, the data protection system (150) may store the information associated with the backups stored in the backup storage system (140) and the corresponding information for accessing each backup. Such information may be used to generate the virtual file system provided to the proxy data mover (100) in accordance with, for example, the method of FIG. 3A.

In one or more embodiments disclosed herein, the backup storage system (150) is implemented as a logical device. The logical device may utilize the computing resources of any number of computing devices and thereby provide the functionality of the backup storage system (140) described throughout this application.

FIG. 2 shows a diagram of an example host in accordance with one or more embodiments of the invention. The host (200) illustrated in FIG. 2 includes: a host operating system (202) that includes a data mover interface manager (204), and host local storage (206). The host (200) may include additional, fewer, and/or different components without departing from the invention.

In one or more embodiments, the data mover interface manager (204) includes functionality for issuing requests for recovery (also referred to as a restoration) of data from a backup image. The requests may be serviced by the proxy data mover (100, FIG. 1) discussed above in accordance with, for example, the method of FIG. 3C.

In one or more embodiments, the communication between the data mover interface manager (204) and the proxy data mover (100, FIG. 1) is performed using the iSCSI protocol. In such embodiments, the data mover interface manager (204) is implemented as an iSCSI initiator, and the virtual file system manager (102, FIG. 1) discussed above is implemented as an iSCSI target. In this manner, the communication between the host (200) and the proxy data mover may be performed independent of the type of the host operating system (202). Any restored data may be stored in the host local storage (206) of the host (200).

FIG. 3A shows a flowchart of a method for configuring a proxy data mover with a virtual file system in accordance with one or more embodiments of the invention. The method shown in FIG. 3A may be performed by, for example, a data protection system (120, FIG. 1). Other components of the system illustrated in FIG. 1 or 2 may perform the method of FIG. 3A without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 300, a virtual file system is created for a backup stored in a backup storage system. The backup may be a backup image of an operating system of a production host. In one or more embodiments, the virtual file system is created by identifying a set of files associated with the backup and mapping each file to the corresponding storage locations of data chunks of each file stored in the backup storage system, in addition to mapping the corresponding hierarchical structure of the set of files in a file system.

In one or more embodiments, the virtual file system may be created by the data protection system based on stored metadata of the backup in the backup storage system. For example, the data protection system may include functionality for initiating backup generation of the backup and storing any metadata used to obtain portions of the backup such as, for example, files, configurations of the operating system, application data for an application in the operating system, and/or any other portions of the backup image without departing from the invention. Each of the set of files mapped in the virtual file system may be referred to as a virtual synthetic file.

In step 302, the virtual file system is exported to a proxy data mover (e.g., 100, FIG. 1). In one or more embodiments, the data protection system provides the virtual file system to the proxy data mover via any transmission or exporting mechanism without departing from the invention. For example, the virtual file system may be exported via a network file system (NFS) protocol. The exporting may include mounting the virtual file system in the proxy data mover.

FIG. 3B shows a flowchart of a method for generating a set of subsystem volumes in accordance with one or more embodiments of the invention. The method shown in FIG. 3B may be performed by, for example, a proxy data mover (100, FIG. 1). Other components of the system illustrated in FIG. 1 or 2 may perform the method of FIG. 3B without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 320, the virtual file system is obtained from the data protection system. As discussed in FIG. 3A, the obtained virtual file system may include any number of virtual synthetic files.

In step 322, a set of backend objects are generated for each file associated with the backup. In one or more embodiments, each backend objects includes metadata for accessing data (e.g., associated with one of the virtual synthetic file) in a backup storage system. The metadata of a backend object may include the storage locations of every chunk of the data associated with the virtual synthetic file. The metadata may be used by the proxy data mover to access the corresponding data by communicating with the backup storage system using, for example, the NFS protocol.

In step 324, a storage identifier is generated for each backend object. In one or more embodiments, the storage identifier is a data structure that maps a virtual synthetic file to the corresponding backend object. The storage identifier may be implemented as, for example, a LUN.

In step 326, a subsystem volume is created for each backend using a configuration (e.g., a mapping) of the storage identifiers and the backend objects. In one or more embodiments, a storage identifier and the use for communicating with a corresponding backend object is collectively referred to as a subsystem volume (see FIG. 4A). A subsystem volume is created by configuring the proxy data mover to map the corresponding storage identifier to the backend object such that the backend object is used to access data from the backup storage system when the corresponding storage identifier is specified in a request for data recovery (e.g., see FIG. 3C).

In step 328, the data mover interface agent of a production host is configured with the subsystem volumes. In one or more embodiments, the data mover interface agent is configured by the data protection system by obtaining the storage identifiers of each generated subsystem volume and provided to the data mover interface agent.

While each data mover interface agent may operate in a host operating system, the use of the storage identifiers by the data mover interface agent to perform recoveries of data in a backup image may be performed independent of the type of operating system of the production host. Further, two or more production hosts may be configured with the storage identifiers without departing from the invention.

FIG. 3C shows a flowchart of a method for restoring data from a backup storage system in accordance with one or more embodiments of the invention. The method shown in FIG. 3C may be performed by, for example, a proxy data mover (100, FIG. 1). Other components of the system illustrated in FIG. 1 or 2 may perform the method of FIG. 3C without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 340, a recovery request is obtained. The recovery request may specify recovering a set of one or more files from a backup (e.g., a backup image). The recovery request may include one or more storage identifiers.

In step 342, the backup storage system is accessed using the corresponding subsystem volumes associated with the set of files and using the NFS protocol. In one or embodiments, the subsystem volumes for the set of files are identified using the specified storage identifiers in the recovery request. The storage identifiers may each correspond to a backend object of the identified subsystem volumes. The backend objects of the identified subsystem volumes are used to access the data of the set of files in the backup storage system.

In step 344, a data recovery is performed using the access to the backup storage system to provide the set of files to the host operating system. In one or more embodiments, the data recovery is performed by accessing the backup storage system using the identified subsystem volumes to obtain a copy of the data corresponding to the set of files and providing the data to the production host via the data mover interface agent. The data protection interface agent as such may store the data in the host operating system for use by the host operating system.

### EXAMPLE

To clarify aspects of the invention, the following describes an example in accordance with one or more embodiments of the invention. The example, described using FIGS. 4A-4B, is not intended to limit aspects of the invention. In the example, consider a scenario in which hardware components have been purchased by a client and from a vendor. Actions performed by components of FIGS. 4A-4B may be represented using circled numbers and described below using brackets (e.g., “[1]”).

Turning to the example and to FIG. 4A, consider a scenario in which a data protection system generates backup images of operating systems, and a production host desires to restore a portion of the data in the backup image. FIG. 4A shows a diagram of the example system. The example system includes the data protection system (420), a proxy data mover (400), a backup storage system (450), and a production host (430).

At a first point in time, the data protection system (420) generates the backup image (452) and stores the metadata associated with the backup image (452) [1]. The metadata is used to store a virtual file system that includes a set of virtual synthetic image files (454, 456) that each correspond to a portion of the data in the backup image (452). The virtual file system is exported to the proxy data mover (400) using the NFS protocol.

In response to receiving the virtual file system, a virtual file system manager (402) of the proxy data mover (400) generates a set of subsystem volumes (404) that each include a storage identifier (404) and a backend object (410) as discussed above in FIG. 1 [3].

The storage identifiers (e.g., 408) are provided to the data protection system (420). The data protection system (420) masks the storage identifiers to be provided to a production host (430) [4]. Specifically, a data mover interface agent (434) is used to perform the recovery of the data in the backup image (452) to the production host (430), and the data mover interface agent (434) obtains the storage identifiers and uses the storage identifiers for the recovery in accordance with FIG. 4B discussed below.

In this example, the storage identifier (e.g., 408) of each subsystem volume (404, 406) is implemented as a LUN. Further, the virtual file system manager (402) is implemented as an iSCSI target component, and a data mover interface agent (434) of the production host (430) is implemented as an iSCSI initiator. As such, the data mover interface agent (434) and the virtual file system manager (402) communicate using the iSCSI protocol. In an alternative example, the data mover interface agent (434) and the virtual file system manager (402) communicate using NVMe over TCP.

Turning to FIG. 4B, after the data mover interface agent (434) has obtained the storage identifiers for the virtual synthetic image files (454, 456) of the backup image (452), the data mover interface agent (452) may request to recover a portion of data from the backup image (452). The request is sent to the virtual file system manager (402) in the iSCSI protocol [5]. The request specifies the storage identifiers for the portion of data. The virtual file system manager (402) identifies the subsystem volumes (404, 406) of the corresponding to the specified storage identifiers [6]. Using the backend objects (not shown) of the identified subsystem volumes (404, 406), the virtual file system manager (402) communicates with the backup storage system (450) in the NFS protocol to obtain the relevant data from the backup image (452) [7]. The data is provided to the production host (430) [8].

### End of Example

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computer (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention utilize a proxy data mover to provide methods for restoring data from a large backup image that represents an entire operating system by providing subsystem volumes that map virtual synthetic files to portions of the backup image. In this manner, a portion of the data is restored to a host OS without requiring any data transfer of the full backup image from the backup storage system. Further, embodiments of the invention provide such restoration operations independent of the operating system on which the data mover interface agent. For example, the data mover interface agent may be equipped with the requisite protocol (e.g., iSCSI or NVMe over TCP) to communicate with the proxy data mover to initiate the restoration.

Thus, embodiments of the invention may address the problem of inefficient use of computing resources. This problem arises due to the technological nature of the environment in which file systems are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for recovery of a portion of a backup image, the method comprising:
obtaining, by a proxy data mover and from a host operating system, a request for accessing a file in the backup image;
in response to the request:
utilizing a virtual file system manager to identify, from a plurality of subsystem volumes, a subsystem volume of the plurality of subsystem volume associated with the file,
wherein the subsystem volume is used to identify a storage location of the file in the backup image,
wherein each of the plurality of subsystem volumes is associated with a portion of the backup image;
accessing a backup storage system using the subsystem volumes to access the backup image;
obtaining, after the accessing, the file from the backup image; and
providing the file to the host operating system.

2. The method of claim 1, further comprising:
obtaining, from a data protection system, a virtual file system, wherein the data protection system creates the virtual file system using the backup image stored in the backup storage system.

3. The method of claim 2, further comprising:
generating, by the proxy data mover, a set of backend objects associated with the backup image, wherein each backend object corresponds to one of a plurality of files in the backup image;
generating a storage identifier for each of the set of backend objects; and
creating the plurality of subsystem volumes using a mapping of the backend objects to the storage identifier of each of the set of backend objects.

4. The method of claim 3, wherein the storage identifier of each of the set of backend objects is each represented as a logical unit number (LUN).

5. The method of claim 2, wherein the host operating system comprises a data mover interface agent, and wherein the data protection system configures the data mover interface agent with a portion of the virtual file system.

6. The method of claim 5, wherein the virtual file system manager is an internet small computer system interface (iSCSI) target, and wherein the data mover interface agent is an iSCSI initiator.

7. The method of claim 5, wherein the data mover interface agent and the virtual file system manager communicate with each other via non-volatile memory express (NVMe) over transmission control protocol (TCP) based on the configuration of the data mover interface agent with the portion of the virtual file system.

8. A non-transitory computer readable medium comprising computer readable program code, which when executed by a computer processor enables the computer processor to perform a method for recovery of a portion of a backup image, the method comprising:
obtaining, by a proxy data mover and from a host operating system, a request for accessing a file in a backup image;
in response to the request:
utilizing a virtual file system manager to identify, from a plurality of subsystem volumes, a subsystem volume of the plurality of subsystem volume associated with the file,
wherein the subsystem volume is used to identify a storage location of the file in the backup image,
wherein each of the plurality of subsystem volumes is associated with a portion of the backup image;
accessing, after the accessing, a backup storage system using the subsystem volumes to access the backup image;
obtaining the file from the backup image; and
providing the file to the host operating system.

9. The non-transitory computer readable medium of claim 8, the method further comprising:
obtaining, from a data protection system, a virtual file system, wherein the data protection system creates the virtual file system using the backup image stored in the backup storage system.

10. The non-transitory computer readable medium of claim 9, the method further comprising:
generating, by the proxy data mover, a set of backend objects associated with the backup image, wherein each backend object corresponds to one of a plurality of files in the backup image;
generating a storage identifier for each of the set of backend objects; and
creating the plurality of subsystem volumes using a mapping of the backend objects to the storage identifier of each of the set of backend objects.

11. The non-transitory computer readable medium of claim 10, wherein the storage identifier of each of the set of backend objects is each represented as a logical unit number (LUN).

12. The non-transitory computer readable medium of claim 9, wherein the host operating system comprises a data mover interface agent, and wherein the data protection system configures the data mover interface agent with a portion of the virtual file system.

13. The non-transitory computer readable medium of claim 12, wherein the virtual file system manager is an internet small computer system interface (iSCSI) target, and wherein the data mover interface agent is an iSCSI initiator.

14. The non-transitory computer readable medium of claim 12, wherein the data mover interface agent and the virtual file system manager communicate with each other via non-volatile memory express (NVMe) over transmission control protocol (TCP) based on the configuration of the data mover interface agent with the portion of the virtual file system.

15. A system comprising:
a proxy data mover operating on a processor; and
memory comprising instructions, which when executed by the processor, perform a method comprising:
obtaining, from a host operating system, a request for accessing a file in a backup image;
in response to the request:
utilizing a virtual file system manager of the proxy data mover to identify, from a plurality of subsystem volumes, a subsystem volume of the plurality of subsystem volume associated with the file,
wherein the subsystem volume is used to identify a storage location of the file in the backup image,
wherein each of the plurality of subsystem volumes is associated with a portion of the backup image;
accessing a backup storage system using the subsystem volumes to access the backup image;
obtaining the file from the backup image; and
providing the file to the host operating system.

16. The system of claim 15, the method further comprising: obtaining, from a data protection system, a virtual file system, wherein the data protection system creates the virtual file system using the backup image stored in the backup storage system.

17. The system of claim 16, the method further comprising:
generating, by the proxy data mover, a set of backend objects associated with the backup image, wherein each backend object corresponds to a file in the backup image;
generating a storage identifier for each of the set of backend objects; and
creating the plurality of subsystem volumes using a configuration of the backend objects to the storage identifier of each of the set of backend objects.

18. The system of claim 16, wherein the host operating system comprises a data mover interface agent, and wherein the data protection system configures the data mover interface agent with a portion of the virtual file system.

19. The system of claim 18, wherein the virtual file system manager is an internet small computer system interface (iSCSI) target, and wherein the data mover interface agent is an iSCSI initiator.

20. The system of claim 18, wherein the data mover interface agent and the virtual file system manager communicate with each other via non-volatile memory express (NVMe) over transmission control protocol (TCP) based on the configuration of the data mover interface agent with the portion of the virtual file system.
